(19) United States
(12) Patent Application Publication
(10) Pub. No.: US 2014/0307442 A1
(43) Pub. Date: Oct. 16, 2014

(54) LIGHT EMITTING DEVICE

(71) Applicant: Shao-Ying Ting, Tainan City (TW)

(72) Inventor: Shao-Ying Ting, Tainan City (TW)

(73) Assignee: GENESIS PHOTONICS INC., Tainan City (TW)

(21) Appl. No.: 13/950,305

(22) Filed: Jul. 25, 2013

(30) Foreign Application Priority Data
Apr. 11, 2013 (TW) 102112874

(51) Int. Cl. F21K 99/00

(52) U.S. Cl. CPC F21K 9/56
USPC 362/293

(57) ABSTRACT

A light emitting device includes a light emitting diode (LED) module and a rotatable wavelength converting structure. The LED module includes a substrate and a plurality of LED chips. The LED chips are disposed on the substrate, and each of the LED chips has a light emitting surface. The rotatable wavelength converting structure is disposed on the LED module and has a plurality of wavelength converting blocks with at least two different colors. Each of the LED chips at least corresponds to one wavelength converting block. The wavelength converting blocks are disposed on the light emitting surfaces of the LED chips. The rotatable wavelength converting structure rotates relative to the LED module so as to change the wavelength converting blocks that the LED chips correspond to.

### CROSS-REFERENCE TO RELATED APPLICATION

This application claims the priority benefit of Taiwan application serial no.

102112874, filed on Apr. 11, 2013. The entirety of the above-mentioned patent application is hereby incorporated by reference herein and made a part of this specification.

### BACKGROUND OF THE INVENTION

1. Field of the Invention

The present invention relates to a light emitting device, and more particularly, to a light emitting device having light emitting diode chips as a light source.

2. Description of Related Art

Following the continuous enhancement of brightness and light emitting efficiency of light emitting diodes in recent years, the light emitting diodes are gradually being used for lighting purpose, and light emitting diode light sources (e.g. bulb, road light, torch) or relevant lighting devices are being developed. However, lights produced by common power-saving bulbs or light emitting diode lighting devices have a fixed color temperature, which may cause inconvenience to the user.

In general, a white light source having a high color temperature is usually suitable in work situation or a situation where color is required to be accurately distinguished, while a white light source having a low color temperature is suitable for living environment to build a warm atmosphere. Therefore, different work or different situation needs lights of different color temperatures. However, current light emitting diode lighting devices having fixed color temperature cannot satisfy this requirement.

### SUMMARY OF THE INVENTION

Accordingly, the present invention is directed to a light emitting device which is capable of changing the color temperature by a rotation of the rotatable wavelength converting structure relative to the light emitting diode module.

The present invention provides a light emitting device including a light emitting diode module and a rotatable wavelength converting structure. The light emitting diode module includes a substrate and a plurality of light emitting diode chips disposed on the substrate and each of the light emitting diode chips having a light emitting surface. The rotatable wavelength converting structure is disposed on the light emitting diode module and has a plurality of wavelength converting blocks. The wavelength converting blocks have at least two colors. Each of the light emitting diode chips at least corresponds to one wavelength converting block. The wavelength converting blocks are disposed on the light emitting surfaces of the light emitting diode chips, and the rotatable wavelength converting structure rotates relative to the light emitting diode module to change the wavelength converting blocks that the light emitting diode chips correspond to.

In one embodiment, the substrate of the light emitting diode module and the rotatable wavelength converting structure are conformally disposed, and a shape of the substrate and the rotatable wavelength converting structure comprises hollow ring, circle or regular polygon.

In one embodiment, the light emitting device further includes a light base and a rotating member. The rotating member is fixed to the light base and connected with the rotatable wavelength converting structure. The light emitting diode module is fixed to the light base.

In one embodiment, the rotating member comprises a fixing member that can be fixed to the light base and a rotating shaft that is connected with the rotatable wavelength converting structure. Rotating of the rotating shaft relative to the fixing member causes a relative rotation between the rotatable wavelength converting structure and the light emitting diode module.

In one embodiment, the light emitting diode chips are equidistantly arranged on the substrate.

In one embodiment, the light emitting diode chips are a combination of light emitting diode chips emitting lights of different colors.

In one embodiment, the light emitting device further includes a light base and a light shade. The light shade is disposed on the light base and cooperates with the light base to define an accommodating space. The light emitting diode module and the rotatable wavelength converting structure are disposed in the accommodating space. The light emitting diode module is fixed to the light base, and the rotatable wavelength converting structure is fixed to the light shade.

In one embodiment, the light base includes a first positioning portion, the light shade includes a second positioning portion, and the light base and the light shade are rotatably positioned through the first positioning portion and the second positioning portion to cause a relative rotation between the rotatable wavelength converting structure and the light emitting diode module.

In one embodiment, the light shade is a light guide light shade, and the light guide light shade has an inner surface, an outer surface, and a connecting surface connecting the inner surface and the outer surface. A curvature of the inner surface is greater than a curvature of the outer surface.

In one embodiment, the light emitting device further includes a reflective film disposed on the inner surface of the light guide light shade.

In one embodiment, the light emitting device further includes a reflective layer disposed on the inner surface of the light guide light shade. The reflective layer includes a plurality of reflective particles, and a density of the reflective particles in the reflective layer gradually increases in a direction away from the connecting surface.

In summary, the rotatable wavelength converting structure of the present invention can rotate relative to the light emitting diode module to change the wavelength converting blocks that the light emitting diode chips correspond to. Therefore, in addition to the capability of providing lights of different color temperatures, the light emitting device of the present invention can be widely employed in various applications, thereby increasing the convenience of use of the light emitting device of the present invention.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1 is a schematic three-dimensional view of a light emitting device according to one embodiment of the present invention.

FIG. 2 is a schematic three-dimensional view of a light emitting device according to another embodiment of the present invention.

FIG. 3A is a schematic three-dimensional view of a light emitting device according to another embodiment of the present invention.

FIG. 3B is a schematic cross-sectional view of FIG. 3A taken along line A-A′ thereof.

FIG. 4 is a schematic cross-sectional view of a light emitting device according to another embodiment of the present invention.

FIG. 5 is a schematic cross-sectional view of a light emitting device according to another embodiment of the present invention.

FIG. 6 is a schematic cross-sectional view of a light emitting device according to another embodiment of the present invention.

FIG. 7 is a schematic cross-sectional view of a light emitting device according to still another embodiment of the present invention.

### DESCRIPTION OF THE EMBODIMENTS

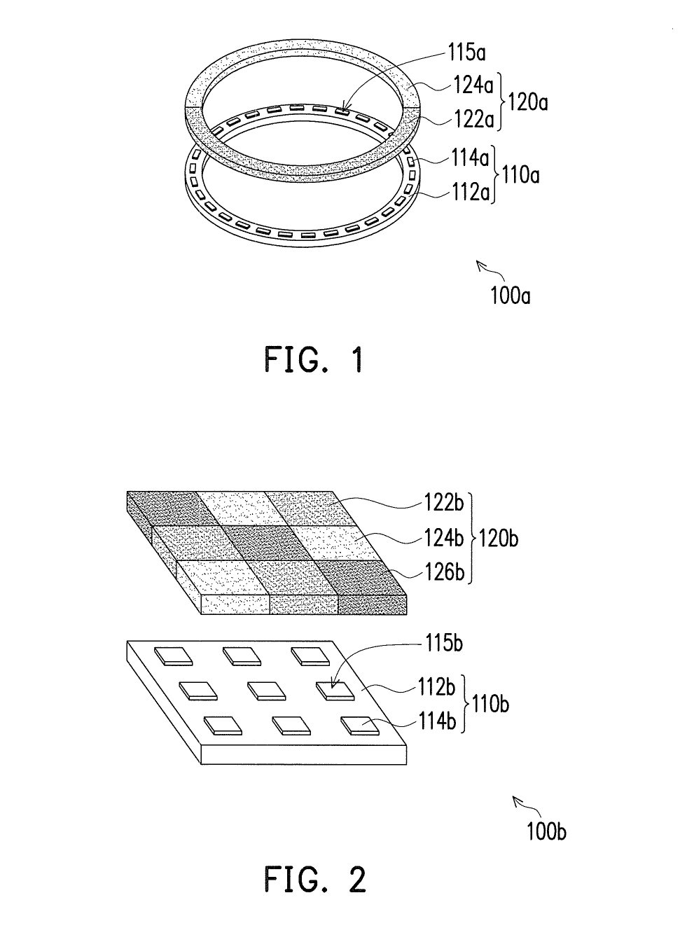

FIG. 1 is a schematic three-dimensional view of a light emitting device according to one embodiment of the present invention. Referring to FIG. 1, in the present embodiment, the light emitting device 100a includes a light emitting diode (LED) module 110a and a rotatable wavelength converting structure 120a. Specifically, the LED module 110a includes a substrate 112a and a plurality of LED chips 114a. The LED chips 114a are disposed on the substrate 112a, and each of the LED chips 114a has a light emitting surface 115a. The rotatable wavelength converting structure 120a is disposed over the LED module 110a and includes a plurality of wavelength converting blocks 122a, 124a (two wavelength converting blocks are illustrated in FIG. 1) having at least two different colors. Each LED chip 114a at least corresponds to one wavelength converting block 122a (or 124a). The wavelength converting blocks 122a, 124a are disposed on the light emitting surface 115a of the LED chip 114a. In particular, the rotatable wavelength converting structure 120a rotates relative to the LED module 110a so as to change the wavelength converting blocks 122a, 124a that the LED chips 114a correspond to.

More specifically, in the present embodiment, the substrate 112a of the LED module 110a and the rotatable wavelength converting block 120a are conformally disposed, i.e. the substrate 112a and the rotatable wavelength converting structure 120a have the same shape. As shown in FIG. 1, the substrate 112a and the rotatable wavelength converting structure 120a, for example, have a hollow ring shape. In the present embodiment, the wavelength converting blocks 122a, 124a have only two colors. The colors of the wavelength converting blocks 122a, 124a are, for example, at least two of green, yellow, red, and blue. The LED chips 114a are equidistantly arranged on the substrate 112a, and each LED chip 114a can correspond to one wavelength converting block 122a (or 124a). Here, the LED chips 114a may be a combination of LED chips emitting different color lights, or optionally comprise LED chips emitting the same color lights.

The rotatable wavelength converting structure 120a of the present embodiment is rotatable relative to the LED module 110a to change the corresponding LED chip 114a. When the light emitted by the LED chip 114a passes through the wavelength converting blocks 122a, 124a of different colors, it generates different color excitation lights. Therefore, the wavelength converting blocks 122a, 124a that the LED chips 114a correspond to are changed by rotating the rotatable wavelength converting structure 120a to thereby generate excitation lights of different colors.

For example, part of LED chips 114a are blue LED chips which correspond to the wavelength converting block 122a such as a yellow wavelength converting block; another part of the LED chips 114a may be green LED chips which correspond to the wavelength converting block 124a such as a red wavelength converting block. Lights produced by this combination have a warm color temperature. When rotating the rotatable wavelength converting structure 120a such that the wavelength converting blocks 122a and 124a that the LED chips 114a correspond to swap their positions, lights with a cold color temperature are produced. Therefore, in addition to providing lights with different color temperatures, the light emitting device 100a of the present embodiment can also adjust, for example, brightness or color rendering index, according to needs and hence can be widely employed in various applications, thereby increasing the convenience of use of the light emitting device 100a of the present embodiment.

It is noted that the present invention has no limitations as to the shape of the substrate 112a and the rotatable wavelength converting structure 120a, the number of the LED chips 114a that each wavelength converting block 122a (or 124a) correspond to, and the number of blocks and colors of the wavelength converting blocks 122a, 124a. In an alternative embodiment, referring to FIG. 2, the shape of the substrate 112b of the LED module 110b and the rotatable wavelength converting structure 120b of the light emitting device 100b may be a regular polygon such as a square. The rotatable wavelength converting structure 120b includes nine wavelength converting blocks 122b, 124b, 126b having three colors, with the wavelength converting blocks 122b, 124b, 126b of different colors being alternatively arranged. Each LED chip 114b correspond to a wavelength converting block 122b (or 124b, 126b), and the wavelength converting blocks 122b, 124b, 126b are disposed over the light emitting surfaces 115b of the LED chips 114b. This solution can be also adopted by the present invention and thus falls within the scope of the present invention.

In addition, in other embodiments not illustrated, people skilled in the art can adjust the shape of the substrates 112a, 112b and the rotatable wavelength converting structures 120a, 120b, the number of the wavelength converting blocks (e.g. 122a, 124a, 122b, 124b, 126b), the number of colors and the number of corresponding LED chips 114a, 114b to achieve desired results according to needs, which is not repeated herein.

It is noted that the following embodiments continues using the reference numerals and partial contents of the previous embodiment, wherein the same reference numerals denote the same or similar elements and description of the same contents is omitted. Reference can be made to the previous embodiment for the description of the omitted part which is not repeated herein.

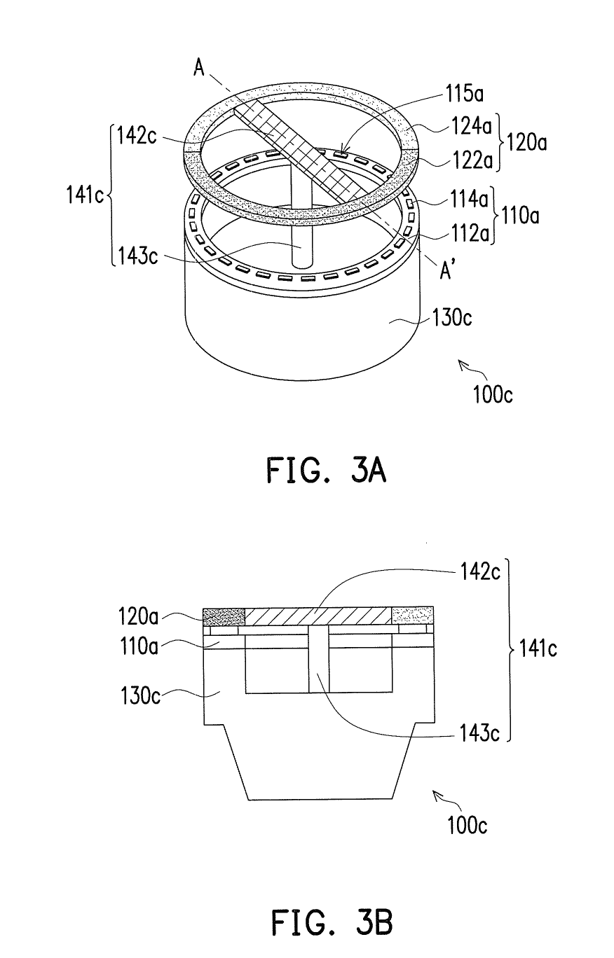

FIG. 3A is a schematic three-dimensional view of a light emitting device according to one embodiment of the present invention. FIG. 3B is a schematic cross-sectional view of FIG. 3A, taken along line A-A′ thereof For ease of illustration, some elements are shown in a three-dimensional exploded manner in FIG. 3A. Referring to FIG. 3A and FIG. 3B, the light emitting device 100c of the present embodiment is similar to the light emitting device 100a of FIG. 1, except that the light emitting device 100c of the present embodiment further includes a light base 130c and a rotating member 141c. The LED module 110a is fixed to the light base 130c and electrically connected with an actuator (not shown) in the light base 130c. The rotating member 141c is fixed to the light base 130c and connected with the rotatable wavelength converting structure 120a. More specifically, the rotating member 141c includes a fixing member 143c and a rotating shaft 142c. The rotating member 141c is fixed to the light base 130c using the fixing member 143c. The rotating member 141c is connected with the rotatable wavelength converting structure 120a through the rotating shaft 142c. The rotating shaft 142c is, for example, a rotatable rotary bracket. Here, the LED module 110a, fixing member 143c and rotatable wavelength converting structure 120a can be fixed to the light base 130c, light base 130c and rotary shaft 142c, respectively, in various manners such as, but not limited to, by screw-fastening, magnetic adsorption, snap-locking, or adhesive. Specifically, because the fixing member 143c of the rotating member 141c is fixed to the light base 130c, rotating the rotatable wavelength converting structure 120a by, for example, rotating the rotating shaft 142c, can cause relative rotation between the rotatable wavelength converting structure 120a and the LED module 110a to thereby change the color of the emitting light of the light emitting device 100c. Therefore, in addition to the capability of providing lights of different color temperatures, the present light emitting device 100c can also adjust the brightness or color rendering index according to needs, and hence can be widely employed in various applications, thereby increasing the convenience of use of the light emitting device 100c of the present embodiment.

FIG. 4 is a schematic cross-sectional view of a light emitting device according to another embodiment of the present invention. Referring to FIG. 4, the light emitting device 100d of the present embodiment is similar to the light emitting device 100a of FIG. 1, except that the light: emitting device 100d of the present embodiment further includes a light base 130d and a light shade 140d. Specifically, the light shade 140d is disposed on the light base 130d and cooperates with the light base 130d to define an accommodating space S. The LED module 110a and the rotatable wavelength converting structure 120a are disposed in the accommodating space S. The LED module 110a is fixed to the light base 130d and electrically connected with an actuator (not shown) in the light base 130d, and the rotatable wavelength converting structure 120a is fixed to the light shade 140d. Here, the LED module 110a and the rotatable wavelength converting structure 120a can be fixed to the light base 130d and the light shade 140d, respectively, in various manners such as, but not limited to, by screw-fastening, magnetic adsorption, snap-locking or adhesive. Specifically, the light base 130d has a first positioning portion 132d, the light shade 140d has a second positioning portion 142d, and the light base 130d and the light shade 140d are rotatably positioned through the first positioning portion 132d and the second positioning portion 142d to cause a relative rotation between the rotatable wavelength converting structure 120a and the LED module 110a. That is, one first positioning portion 132d can be engaged with one second positioning portion 142d and, through rotation, the second positioning portion 142d that was previously engaged with one first positioning portion 132d can be changed. Alternatively, the first positioning portion 132d that was previously engaged with one second positioning portion 142d can be changed.

As shown in FIG. 4, the light emitting device 110d is, for example, a downlight, the light shade 140d is a barrel shaped light shade, the first positioning portion 132d is a locking slot, and the second positioning portion 142d is a locking block. However, the present invention is not intended to limit the light shade 140d, the first positioning portion 132d and the second positioning portion 142d to any particular form. In other embodiments not illustrated, the light emitting device 110d may also be a bulb or a candle lamp, and the light shade 140d may also be a paraboloid light shade or an ellipsoid light shade. The second positioning portion 142d may be a locking slot, and the first positioning portion 132d may be a locking block. Alternatively, the first positioning portion 132d and the second positioning portion 142d may be positioned through screw-fastening or magnetic adsorption. These can all be adopted by the present invention and thus fall within the scope of the present invention.

The light base 130d and the light shade 140d of the present embodiment can relatively rotate through the first positioning portion 132d and the second positioning portion 142d to cause the relative rotation between the rotatable wavelength converting structure 120a and the LED module 110a, thereby changing the color of the emitting light of the light emitting device 100d. Therefore, in addition to the capability of providing lights of different color temperatures, the present light emitting device 100d can adjust the brightness or color rendering index according to needs, and hence can be widely employed in various applications, thereby increasing the convenience of use of the light emitting device 100d of the present embodiment.

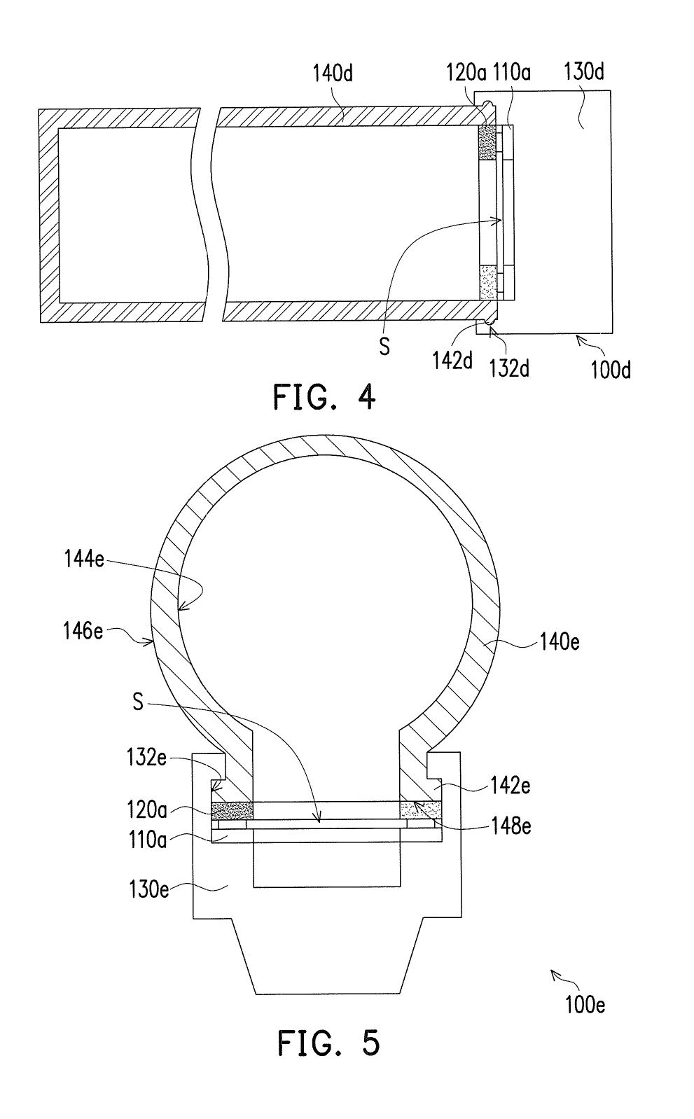

FIG. 5 is a schematic cross-sectional view of a light emitting device according to another embodiment of the present invention. Referring to FIG. 5, the light emitting device 100e of the present embodiment is similar to the light emitting device 100d of FIG. 4, except that the light shade 140e of the light emitting device 100e in the present embodiment is a light guide light shade. The light guide light shade has an inner surface 144e, an outer surface 146e, and a connecting surface 148e connecting the inner surface 144e and the outer surface 146e. Specifically, a curvature of the inner surface 144e is greater than a curvature of the outer surface 146e. Here, as shown in FIG. 5, the light shade 140e is ellipsoid in shape. That is, the light shade 140e is an ellipsoid light shade.

The light base 130e and the light shade 140e of the present embodiment can relatively rotate through the first positioning portion 132e and the second positioning portion 142e to cause the relative rotation between the rotatable wavelength converting structure 120a and the LED module 110a, thereby changing the color of the emitting light of the light emitting device 100e. Therefore, in addition to the capability of providing lights of different color temperatures, the present light emitting device 100e can adjust the brightness or color rendering index according to needs, and hence can be widely employed in various applications, thereby increasing the convenience of use of the light emitting device 100e of the present embodiment. In addition, the light shade 140e of the light emitting device 100e has the light guide function, and the curvature of the inner surface 144e of the light shade 140e is greater than the curvature of the outer surface 146e. Therefore, the light emitted from the LED module 110a can be prevented from concentrating in the front direction by designing the light shade 140e. That is, the light can be uniformized. Therefore, the light emitting device 100e can have good light uniformity to thereby avoid glare. Moreover, the light emitted from the LED module 110a can be guided by the light guide light shade 140e, such that the light emitting device 100e has an overall larger light emitting angle (i.e. all round angle?) in comparison with the conventional light emitting device. Here, as shown in FIG. 5, the light emitting device 100e is, for example, a bulb. In alternative embodiments not illustrated, the light emitting device 100e may also be a tube light, a down light, or a candle light. These can all be adopted by the present invention and thus fall within the scope of the present invention.

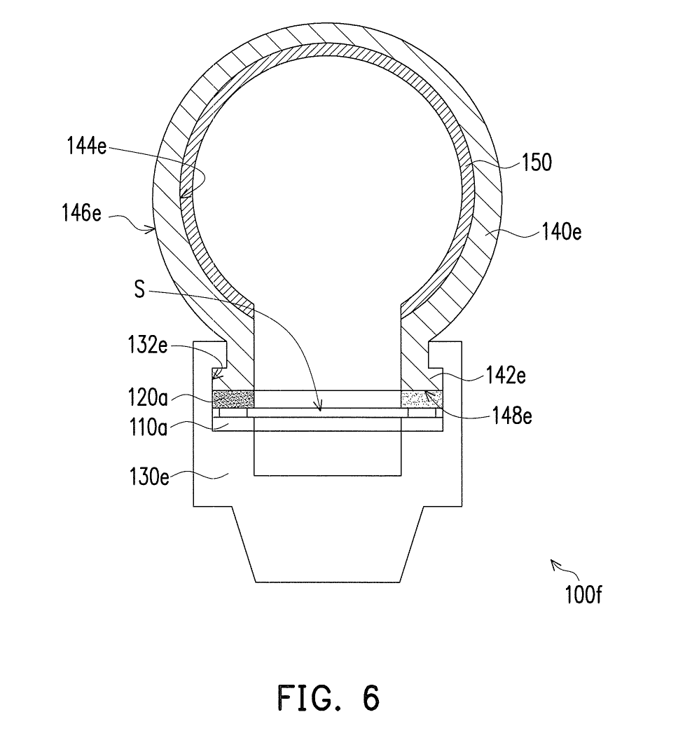

FIG. 6 is a schematic cross-sectional view of a light emitting device according to another embodiment of the present invention. Referring to FIG. 6, the light emitting device 100f of the present embodiment is similar to the light emitting device 100e of FIG. 5, except that the light emitting device 100f of the present embodiment further includes a reflective film 150 that is disposed on the inner surface 144e of the light shade 140e. Here, as shown in FIG. 6, the reflective film 150 is a film with a uniform thickness, and the reflective film 150 and the inner surface 144e of the light shade 140e are conformally disposed. That is, the curvature of the reflective film 150 is substantially the same as the curvature of the inner surface 144e. Because the light emitting device 100f of the present embodiment has the reflective film 150, the light emitted from the LED module 110a can be reflected by the reflective film 150, thus increasing the overall light emitting uniformity and efficiency of the light emitting device 100f.

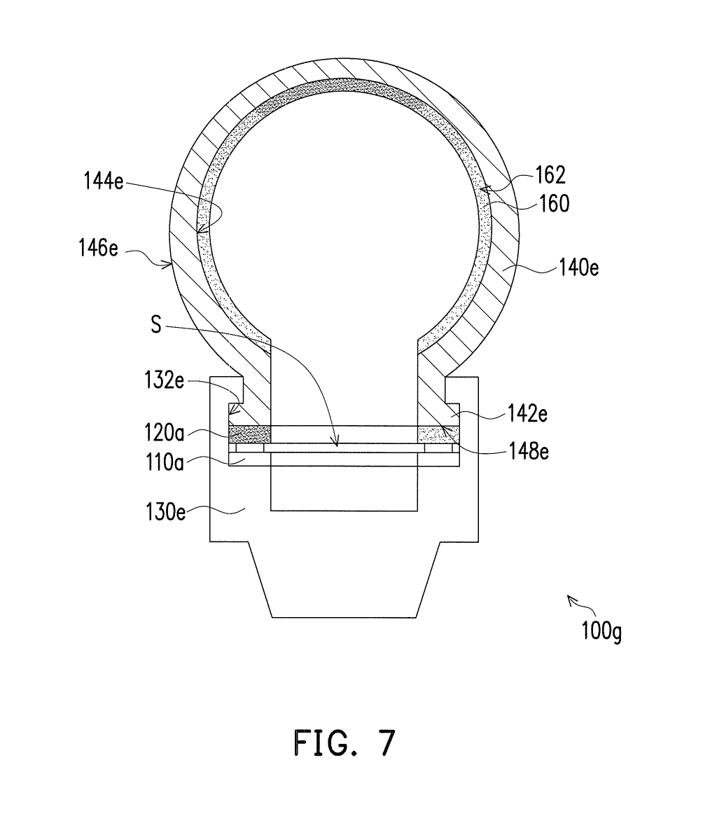

FIG. 7 is a schematic cross-sectional view of a light emitting device according to still another embodiment of the present invention. Referring to FIG. 7, the light emitting device 100g of the present embodiment is similar to the light emitting device 100e of FIG. 5, except that the light emitting device 100g of the present embodiment further includes a reflective layer 160 that is conformally disposed on the inner surface 144e of the light shade 140e. Here, as shown in FIG. 7, the reflective layer 160 is a film with a uniform thickness, and the curvature of the reflective layer 160 is substantially the same as the curvature of the inner surface 144e. In particular, the reflective layer 160 of the present embodiment includes a plurality of reflective particles 162, and the density of the reflective particles 162 in the reflective layer 160 gradually increases in a direction away from the connecting surface 148e. Because the light emitting device 100g of the present embodiment has the reflective layer 160, the light emitted from the LED module 110a can be reflected by the reflective particles 162, thus increasing the overall light emitting uniformity and efficiency of the light emitting device 100g.

In addition, in alternative embodiments not illustrated, the light base 130c, 130d, 130e, light shade 140d, 140e, reflective film 150 or reflective film 160 described in the embodiments above can be selectively and optionally used by people skilled in the art according to needs based on the description of the embodiments above.

In summary, the rotatable wavelength converting structure of the present invention can rotate relative to the LED module to change the wavelength converting blocks that the LED chips correspond to. Therefore, in addition to the capability of providing lights of different color temperatures, the light emitting device of the present invention can also adjust the brightness or color rendering index according to needs, and hence can be widely employed in various applications, thereby increasing the convenience of use of the light emitting device of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting device comprising:
a light emitting diode module comprising:
a substrate; and
a plurality of light emitting diode chips disposed on the substrate and each of the light emitting diode chips having a light emitting surface; and
a rotatable wavelength converting structure disposed on the light emitting diode module and having a plurality of wavelength converting blocks, the wavelength converting blocks having at least two colors, wherein each of the light emitting diode chips at least corresponds to one wavelength converting block, and the wavelength converting blocks are disposed on the light emitting surfaces of the light emitting diode chips, the rotatable wavelength converting structure rotates relative to the light emitting diode module to change the wavelength converting blocks that the light emitting diode chips correspond to.

2. The light emitting device as recited in claim 1, wherein the substrate of the light emitting diode module and the rotatable wavelength converting structure are conformally disposed, and a shape of the substrate and the rotatable wavelength converting structure comprises hollow ring, circle or regular polygon.

3. The light emitting device as recited in claim 1, further comprising:
a light base; and
a rotating member fixed to the light base and connected with the rotatable wavelength converting structure, the light emitting diode module being fixed to the light base.

4. The light emitting device as recited in claim 3, wherein the rotating member comprises a fixing member that can be fixed to the light base and a rotating shaft that is connected with the rotatable wavelength converting structure, and rotating of the rotating shaft relative to the fixing member causes a relative rotation between the rotatable wavelength converting structure and the light emitting diode module.

5. The light emitting device as recited in claim 1, wherein the light emitting diode chips are equidistantly arranged on the substrate.

6. The light emitting device as recited in claim 1, wherein the light emitting diode chips are a combination of light emitting diode chips emitting lights of different colors.

7. The light emitting device as recited in claim 1, further comprising:
a light base; and
a light shade disposed on the light base and cooperating with the light base to define an accommodating space, wherein the light emitting diode module and the rotatable wavelength converting structure are disposed in the accommodating space, the light emitting diode module is fixed to the light base, and the rotatable wavelength converting structure is fixed to the light shade.

8. The light emitting device as recited in claim 7, wherein the light base comprises a first positioning portion, the light shade comprises a second positioning portion, and the light base and the light shade are rotatably positioned through the first positioning portion and the second positioning portion to cause a relative rotation between the rotatable wavelength converting structure and the light emitting diode module.

9. The light emitting device as recited in claim 7, wherein the light shade is a light guide light shade, and the light guide light shade has an inner surface, an outer surface, and a connecting surface connecting the inner surface and the outer surface, and a curvature of the inner surface is greater than a curvature of the outer surface.

10. The light emitting device as recited in claim 9, further comprising a reflective film disposed on the inner surface of the light guide light shade.

11. The light emitting device as recited in claim 9, further comprising a reflective layer disposed on the inner surface of the light guide light shade, wherein the reflective layer comprises a plurality of reflective particles, and a density of the reflective particles in the reflective layer gradually increases in a direction away from the connecting surface.
